(19) United States
(12) Patent Application Publication
(10) Pub. No.: US 2007/0195283 A1
(43) Pub. Date: Aug. 23, 2007

(54) Adjustable light-modulating device

(75) Inventors: Shu-Chen Chan, Kaohsiung City (TW); Ya-Fang Yeh, Changhua Hsien (TW); Yue-Lun Tsai, Tainan Hsien (TW); Sheng-Hsiung Chan, Hsinchu Hsien (TW); Eade Wang, Taipei Hsien (TW)

Correspondence Address: HAMRE, SCHUMANN, MUELLER & LARSON, P.C., P.O. BOX 2902, MINNEAPOLIS, MN, 55402-0902, US

(73) Assignee: DIGIMEDIA TECHNOLOGY CO., LTD., Taipei Hsien (TW)

(21) Appl. No.: 11/396,480

(22) Filed: Apr. 3, 2006

(30) Foreign Application Priority Data
Feb. 21, 2006 (TW) 095105757

(51) Int. Cl. G03B 21/14; G03B 21/00

(52) U.S. Cl. 353/69

(57) ABSTRACT

An adjustable light-modulating device for a projection display apparatus including a color separator capable of providing colored light includes a light valve and an adjusting mechanism. The light valve is disposed to receive the colored light provided by the color separator of the projection display apparatus, and is capable of modulating the colored light. The adjusting mechanism includes a mounting frame to be disposed between the light valve and the color separator, and a securing unit for securing the light valve to the mounting frame such that the light valve is linearly displaceable and tiltable relative to the mounting frame.

### BACKGROUND OF THE INVENTION

1. Field of the Invention

The invention relates to a light-modulating device, more particularly to an adjustable light-modulating device for a projection display apparatus.

2. Description of the Related Art

Projection display apparatus has become a common consumer product in recent years. Optical paths of source light within primary color wavelength ranges, i.e., red, green and blue colored source light, in the projection display apparatus, and optical path of combined modulated image light traveling out of the projection display apparatus are key factors to the quality of images projected by the projection display apparatus. Therefore, adjustments to these optical paths are important in improving the image quality. It is thus required for manufacturers to be able to adjust the location of optical components of the projection display apparatus, such as liquid crystal panels, to desired locations before assembling them together to form the projection display apparatus.

Two conventional methods are available for adjusting the locations of the optical components and for assembling these optical components together to form the projection display apparatus. One conventional method uses a six-axis adjusting device, in addition to adhesives that are cured through exposure to ultraviolet light. The other conventional method utilizes laser welding in addition to the six-axis adjusting device. The “six-axis” refers to linear displacements along three dimension axes —length, width and thickness axes —of the liquid crystal panel, and tilt with respect to these axes. However, the six-axis adjusting device is expensive, large in size, and requires professional maintenance. In addition, thermal expansion coefficients of the adhesives and the optical components having the adhesives applied thereto are usually different, which may arise in inconsistent image quality. Moreover, the time it takes to position optical components to desired locations is long for the method that utilizes laser welding.

Therefore, these two conventional methods for adjusting the locations of the optical components and for assembling these optical components together to form the projection display apparatus are costly and inconvenient.

### SUMMARY OF THE INVENTION

Therefore, the object of the present invention is to provide an adjustable light-modulating device for application to a projection display apparatus, and whose manufacturing and assembly processes are simplified, and whose manufacturing cost is reduced.

According to the present invention, there is provided an adjustable light-modulating device for a projection display apparatus including a color separator that is capable of providing colored light. The adjustable light-modulating device includes a light valve and an adjusting mechanism. The light valve is disposed to receive the colored light provided by the color separator of the projection display apparatus, and is capable of modulating the colored light. The adjusting mechanism includes a mounting frame to be disposed between the light valve and the color separator, and a securing unit for securing the light valve to the mounting frame such that the light valve is linearly displaceable and tiltable relative to the mounting frame.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective view of the preferred embodiment of an adjusting light-modulating device according to the present invention, together with lens mounting seats and a color separator of a projection display apparatus;

FIG. 2 is an assembled schematic view of the preferred embodiment when applied to the projection display apparatus;

FIG. 3 is a top view of the preferred embodiment;

FIG. 4 is a fragmentary exploded sectional view of the preferred embodiment taken along line IV-IV in FIG. 3;

FIG. 5 is a fragmentary assembled sectional view of the preferred embodiment, taken along line IV-IV in FIG. 3, and illustrating a light valve in a leveled position relative to an adjusting mechanism; and

FIG.6 is a fragmentary assembled sectional view of the preferred embodiment similar to FIG. 5, but illustrating the light valve tilted relative to the adjusting mechanism.

### DETAILED DESCRIPTION OF THE PREFERRED EMBODIMENT

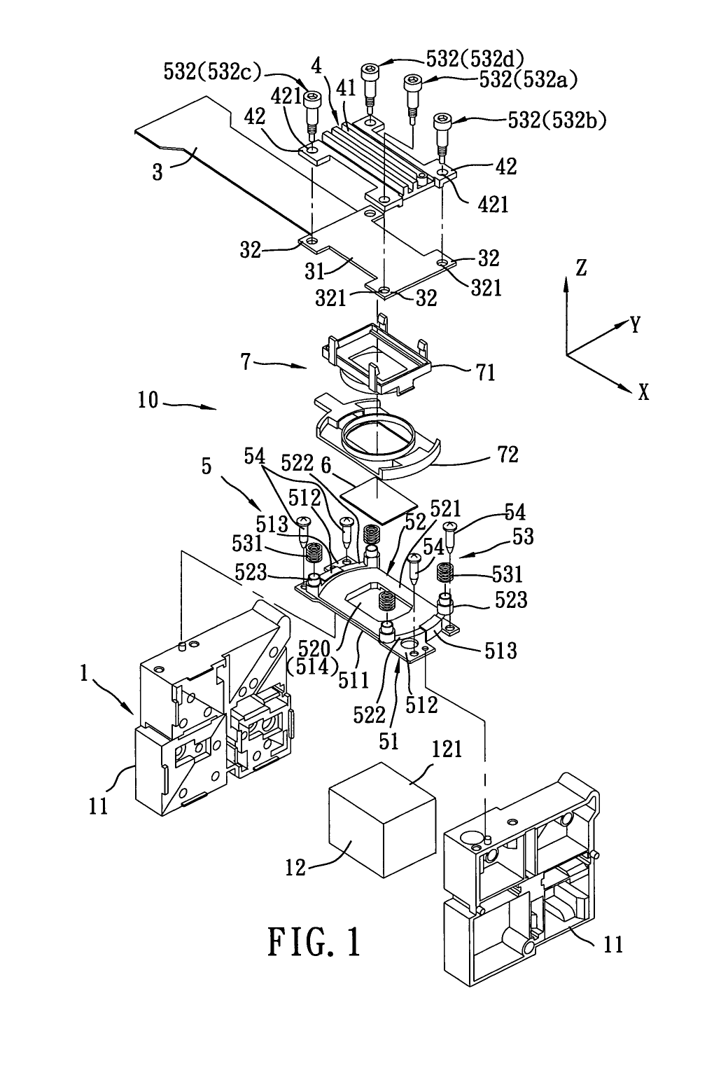

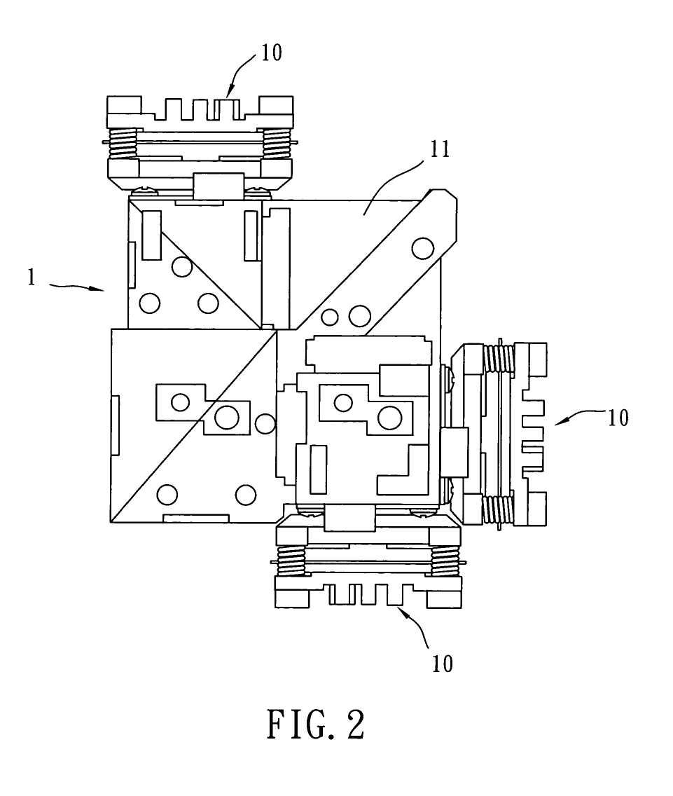

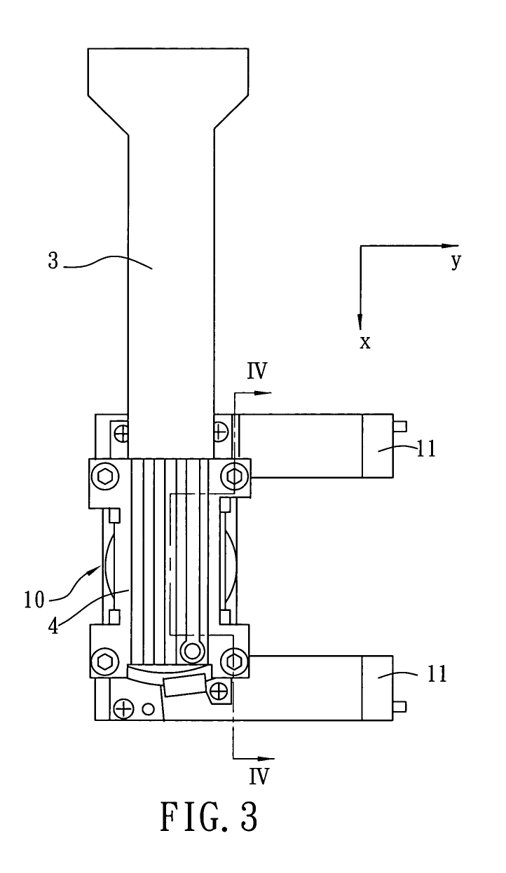

Illustrated in FIG. 1, FIG. 2 and FIG. 3 is the preferred embodiment of three adjustable light-modulating devices 10 according to the present invention that are applied to a projection display apparatus 1. Each of the adjustable light-modulating devices 10 is for modulating a corresponding colored light provided by the projection display apparatus 1, and for adjusting an optical path of the corresponding colored light. Therefore, for a projection display apparatus that only provides two paths of colored light, only two adjustable light-modulating devices 10 will be required. As shown in FIG. 2, the projection display apparatus 1 includes two lens mounting seats 11 (only one is visible in FIG. 2), and a color separator 12 (shown in FIG. 1) clamped between the two lens mounting seats 11. The color separator 12 is capable of providing at least one colored light that travels out of a light-exit side 121 toward a corresponding one of the adjustable light-modulating devices 10.

It is noted herein that only one adjustable light-modulating device 10 is illustrated in FIG. 1. Each of the adjustable light-modulating devices 10 includes a light valve 3, a heat-dissipating member 4, an adjusting mechanism 5, a wave plate 6, and a dust protection member 7.

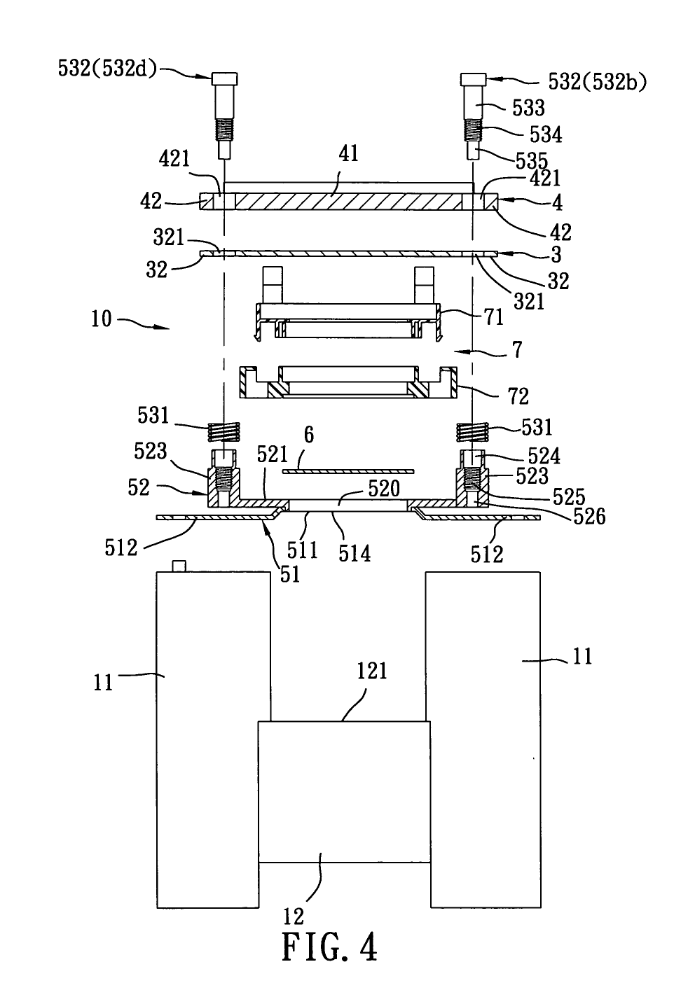

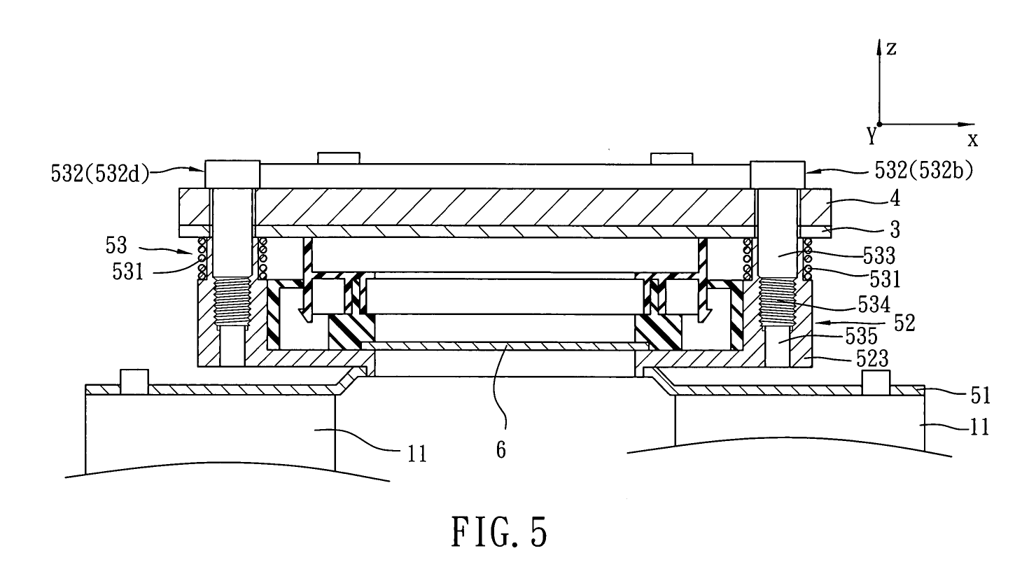

As shown in FIG. 1, FIG. 4 and FIG. 5, the light valve 3 is a reflective liquid crystal panel in this embodiment. According to this embodiment, the color separator 12 of the projection display apparatus 1 is capable of providing three colored light, each of which is within a distinct primary color wavelength range. In other words, the color separator 12 is capable of providing red, green and blue colored light. The light valve 3 of each of the adjustable light-modulating devices 10 is disposed to receive one of the three colored light provided by the color separator 12, and is capable of modulating that particular colored light in a conventional manner. The modulated colored light is then reflected by the corresponding light valves 3, and is subsequently combined into image light.

The light valve 3 is spaced apart from the color separator 12, and confronts the corresponding light-exit side 121. The light valve 3 includes a rectangular plate body 31, and four first securing projections 32 extending from the rectangular plate body 31 and disposed at four corners of the rectangular plate body 31, respectively. Each of the first securing projections 32 is formed with a first fastener hole 321.

The heat-dissipating member 4 is disposed on one side of the light valve 3 opposite to the color separator 12, and includes a rectangular heat-dissipating body 41, and four second securing projections 42 extending from the rectangular heat-dissipating body 41 and disposed at four corners of the rectangular heat-dissipating body 41, respectively. Each of the second securing projections 42 is formed with a second fastener hole 421. In particular, the second fastener holes 421 are registered with the first fastener holes 321 in the first securing projections 32 of the light valve 3, respectively.

The adjusting mechanism 5 includes a fixing frame 51, a mounting frame 52, and a securing unit 53.

The fixing frame 51 is disposed between the mounting frame 52 and the color separator 12 of the projection display apparatus 1, and defines a first through hole 514. The fixing frame 51 is formed with a pair of engaging hooks 513 for engaging the mounting frame 52. In this embodiment, the fixing frame 51 includes a fixing wall 511 having opposite lateral edges 512, and formed with the first through hole 514. The engaging hooks 513 are formed by bending intermediate parts of the opposite lateral edges 512 toward the light valve 3, respectively.

The mounting frame 52 is disposed on the other side of the light valve 3 opposite to the heat-dissipating member 4, is disposed between the light valve 3 and the color separator 12, and defines a second through hole 520. In particular, the mounting frame 52 includes a mounting wall 521 that is formed with the second through hole 520. The mounting wall 521 has opposite curved lateral ends 522, that engage the engaging hooks 513 of the fixing frame 51, and that are each formed with a pair of screw sockets 523. In particular, the engaging hooks 513 on the fixing frame 51 engage slidably and respectively the lateral ends 522 of the mounting frame 52 such that the mounting frame 52 is rotatable relative to the fixing frame 51. In this embodiment, each of the screw sockets 523 has an inner surface formed with an internally threaded portion 525, a small-diameter unthreaded portion 526, and a large-diameter unthreaded portion 524. The small-diameter and large-diameter unthreaded portions 526, 524 are respectively distal from and proximate to the light valve 3. The internally threaded portion 525 is disposed between the small-diameter and large-diameter unthreaded portions 526, 524, and has an internal diameter larger than that of the small-diameter unthreaded portion 526 and smaller than that of the large-diameter unthreaded portion 524.

The securing unit 53 secures the light valve 3 to the mounting frame 52 such that the light valve 3 is linearly displaceable and tiltable relative to the mounting frame 52. In particular, the securing unit 53 includes four first screw fasteners 532 that pass through the heat-dissipating member 4 and the light valve 3 and that engage threadedly the mounting frame 52 such that the heat-dissipating member 4 and the light valve 3 are secured adjustably to the mounting frame 52, and four biasing members 531 provided on the mounting frame 52, disposed respectively around the first screw fasteners 532, and biasing the light valve 3 away from the mounting frame 52. The depth of threaded engagement of each of the first screw fasteners 532 with the mounting frame 52 is adjustable so as to adjust at least one of linear displacement and tilt of the light valve 3 relative to the mounting frame 52.

In this embodiment, each of the first screw fasteners 532 extends through the second fastener hole 421 in the corresponding second securing projection 42 of the heat-dissipating member 4 and the first fastener hole 321 in the corresponding first securing projection 32 of the light valve 3, and includes a first unthreaded section 535, a threaded section 534, and a second unthreaded section 533. The threaded section 534 is disposed between the first and second unthreaded sections 535, 533, and has an outer diameter that is larger than that of the first unthreaded section 535 and smaller than that of the second unthreaded section 533. The first unthreaded section 535 is extended slidably into the small-diameter unthreaded portion 526 of a respective one of the screw sockets 523. The threaded section 534 engages threadedly the internally threaded portion 525 of the respective one of the screw sockets 523. The second unthreaded section 533 is extended slidably into the large-diameter unthreaded portion 524 of the respective one of the screw sockets 523. The second unthreaded section 533 of each of the first screw fasteners 532 has a shank diameter slightly smaller in size than the first fastener holes 321 in the first securing projections 32 of the light valve 3 and the second fastener holes 421 in the second securing projections 42 of the heat-dissipating member 4, as best shown in FIG. 5.

The wave plate 6 is disposed between the mounting frame 52 of the adjusting mechanism 5 and the light valve 3, and is registered with the first through hole 514 in the fixing frame 51 and the second through hole 520 in the mounting frame 52. The dust protection member 7 is disposed between the wave plate 6 and the light valve 3, and is operable to adjust rotatably the position of the wave plate 6 relative to the color separator 12 and the light valve 3. The dust protection member 7 includes a first dust protection frame 71 disposed proximate to the light valve 3, and a second dust protection frame 72 coupled rotatably the first dust protection frame 71. Since the feature of the present invention does not reside in the dust protection member 7, further details of the same are omitted herein for the sake of brevity.

To assemble the adjustable light-modulating device 10, the lateral ends 522 of the mounting frame 52 of the adjusting mechanism 5 are first engaged with the engaging hooks 513 of the fixing frame 51 such that the mounting frame 52 is rotatable relative to the fixing frame 51. Next, the fixing frame 51 is secured to the lens mounting seats 11 of the projection display apparatus 1 via threaded engagement of four second screw fasteners 54 and the lens mounting seats 11. Subsequently, the biasing members 531 of the securing unit 53 are sleeved respectively on the screw sockets 523 at the lateral ends 522 of the mounting frame 52.

Next, the wave plate 6, the dust protection member 7, the light valve 3 and the heat-dissipating member 4 are disposed sequentially on top of the mounting frame 52 of the adjusting mechanism 5. Then, the first screw fasteners 532 are extended through the second fastener holes 421 in the second securing projections 42 of the heat-dissipating member 4 and the first fastener holes 321 in the first securing projections 32 of the light valve 3, and into the screw sockets 523 at the lateral ends 522 of the mounting wall 521 of the mounting frame 52 such that the biasing members 531 are disposed respectively around the first screw fasteners 532. At this time, the threaded section 534 of each of the first screw fasteners 532 engages threadedly the internally threaded portion 525 of the respective one of the screw sockets 523, while the first unthreaded section 535 of each of the first screw fasteners 532 extends into the small-diameter unthreaded portion 526 of the respective one of the screw sockets 523. The second unthreaded section 533 of each of the first screw fasteners 532 extends slidably through respective ones of the second and first fastener holes 421, 321, and partially into the large-diameter unthreaded portion 524 of the respective one of the screw sockets 523.

During use, the colored light traveling out of the corresponding light-exit side 121 of the color separator 12 of the projection display apparatus 1 is projected toward the light valve 3. Control over the location of the light valve 3 on to which the colored light is projected is achieved by adjusting the depth of the threaded engagement of each of the first screw fasteners 532 with the mounting frame 52, where the linear displacement and the tilt of the light valve 3 relative to the mounting frame 52 can be adjusted.

In this embodiment, the linear displacement and the tilt of the light valve 3 relative to the mounting frame 52 are adjustable with respect to three references, i.e., axes (X), (Y) and (Z), where the axis (X) is in the direction of the length of the light valve 3, the axis (Y) is in the direction of the width of the light valve 3, and the axis (Z) is along a normal direction of the light valve 3. The axes (X), (Y) and (Z) are perpendicular to each other. In particular, the light valve 3 is linearly displaceable relative to the axis (Z), and is tiltable about the axes (X) and (Y).

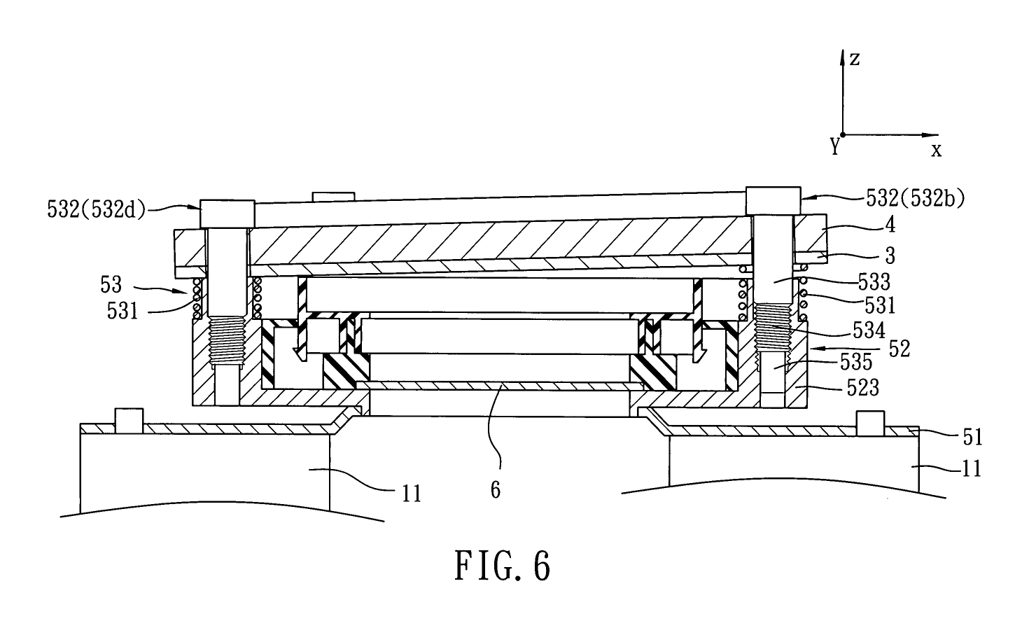

As illustrated in FIG. 5, the light valve 3 is in a leveled position relative to the adjusting mechanism 5, where the depths of the threaded engagement of the first screw fasteners 532 with the mounting frame 52 are the same. More particularly, referring back to FIG.1, when the depths of the threaded engagement of the first screw fasteners 532a, 532b with the mounting frame 52 are adjusted to the same degree so as to be different from those of the first screw fasteners 532c, 532d, the light valve 3 is tilted about the axis (Y), as illustrated in FIG. 6. Similarly, when the depths of the threaded engagement of the first screw fasteners 532c, 532d with the mounting frame 52 are adjusted to the same degree so as to be different from those of the first screw fasteners 532a, 532b, the light valve 3 is tilted about the axis (Y). On the other hand, when the depths of the threaded engagement of the first screw fasteners 532a, 532c with the mounting frame 52 are adjusted to the same degree so as to be different from those of the first screw fasteners 532b, 532d, the light valve 3 is tilted about the axis (X). Similarly, when the depths of the threaded engagement of the first screw fasteners 532b, 532d with the mounting frame 52 are adjusted to the same degree so as to be different from those of the first screw fasteners 532a, 532c, the light valve 3 is tilted about the axis (X). Lastly, the light valve 3 is linearly displaced relative to the axis (Z) by adjusting the depths of threaded engagement of all of the first screw fasteners 532a, 532b, 532c, 532d with the mounting frame 52 to the same degree.

Urging action of the biasing members 531 that constantly bias the light valve 3 away from the mounting frame 52, in addition to the specific configuration of the first screw fasteners 532, i.e., the first unthreaded section 535, the threaded section 534, and the second unthreaded section 533, ensure stability in adjustment of the light valve 3 relative to the mounting frame 52.

In sum, by including the first screw fasteners 532 and the biasing members 531, the light valve 3 is secured adjustably to the mounting frame 52 by the securing unit 53. The depth of the threaded engagement of each of the first screw fasteners 532 with the mounting frame 52 is adjustable so as to adjust the linear displacement and the tilt of the light valve 3 relative to the mounting frame 52. These adjustments are performed with ease, and involve lower costs as compared to the prior art.

While the present invention has been described in connection with what is considered the most practical and preferred embodiment, it is understood that this invention is not limited to the disclosed embodiment but is intended to cover various arrangements included within the spirit and scope of the broadest interpretation and equivalent arrangements.

What is claimed is:

1. An adjustable light-modulating device for a projection display apparatus including a color separator that is capable of providing colored light, said adjustable light-modulating device comprising:
a light valve disposed to receive the colored light provided by the color separator of the projection display apparatus, and capable of modulating the colored light; and
an adjusting mechanism including a mounting frame to be disposed between said light valve and the color separator, and a securing unit for securing said light valve to said mounting frame such that said light valve is linearly displaceable and tiltable relative to said mounting frame.

2. The adjustable light-modulating device as claimed in claim 1, wherein said light valve is a liquid crystal panel.

3. The adjustable light-modulating device as claimed in claim 1, wherein said securing unit of said adjusting mechanism includes:
four screw fasteners that pass through said light valve and that engage threadedly said mounting frame; and
four biasing members provided on said mounting frame, disposed respectively around said screw fasteners, and biasing said light valve away from said mounting frame;
wherein depth of threaded engagement of each of said screw fasteners with said mounting frame is adjustable so as to adjust at least one of linear displacement and tilt of said light valve relative to said mounting frame.

4. The adjustable light-modulating device as claimed in claim 3, further comprising a heat-dissipating member disposed on one side of said light valve opposite to said mounting frame, said screw fasteners further passing through said heat-dissipating member such that said heat-dissipating member and said light valve are adjustably secured to said mounting frame.

5. The adjustable light-modulating device as claimed in claim 3, wherein said adjusting mechanism further includes a fixing frame to be disposed between said mounting frame and the color separator and formed with a pair of engaging hooks for engaging said mounting frame.

6. The adjustable light-modulating device as claimed in claim 5, wherein said mounting frame has opposite lateral ends that engage said engaging hooks of said fixing frame and that are each formed with a pair of screw sockets, each of said screw sockets having an inner surface formed with an internally threaded portion to engage a respective one of said screw fasteners.

7. The adjustable light-modulating device as claimed in claim 6, wherein:
said inner surface of each of said screw sockets is further formed with a small-diameter unthreaded portion and a large-diameter unthreaded portion respectively distal from and proximate to said light valve, said internally threaded portion being disposed between said small-diameter and large-diameter unthreaded portions and having an internal diameter larger than that of said small-diameter unthreaded portion and smaller than that of said large-diameter unthreaded portion,
each of said screw fasteners including a first unthreaded section extended slidably into said small-diameter unthreaded portion of the respective one of said screw sockets, a threaded section engaging threadedly said internally threaded portion of the respective one of said screw sockets, and a second unthreaded section extended slidably into said large-diameter unthreaded portion of the respective one of said screw sockets.

8. The adjustable light-modulating device as claimed in claim 6, wherein said engaging hooks on said fixing frame engage slidably and respectively said lateral ends of said mounting frame such that said mounting frame is rotatable relative to said fixing frame.

9. The adjustable light-modulating device as claimed in claim 3, wherein said light valve is formed with four fastener holes to permit said screw fasteners to pass therethrough, each of said screw fasteners having a shank diameter slightly smaller in size than said fastener holes in said light valve.

10. The adjustable light-modulating device as claimed in claim 4, each of said light valve and said heat-dissipating member is formed with four fastener holes to permit said screw fasteners to pass therethrough, each of said screw fasteners having a shank diameter slightly smaller in size than said fastener holes in said light valve and said heat-dissipating member.

11. The adjustable light-modulating device as claimed in claim 1, further comprising a wave plate disposed between said mounting frame of said adjusting mechanism and said light valve.

12. The adjustable light-modulating device as claimed in claim 11, further comprising a dust protection member disposed between said wave plate and said light valve.
